(19) United States
(12) Patent Application Publication
(10) Pub. No.: US 2018/0247478 A1
(43) Pub. Date: Aug. 30, 2018

(54) OPTICAL DEVICE HAVING AN OPTICAL ARRAY

(71) Applicant: CCL Secure Pty Ltd, Craigieburn, Victoria (AU)

(72) Inventors: Robert Arthur Lee, Craigieburn, Victoria (AU); Gary Fairless Power, Craigieburn, Victoria (AU)

(73) Assignee: CCL Secure Pty Ltd, Craigieburn, Victoria (AU)

(21) Appl. No.: 15/753,309

(22) PCT Filed: Aug. 18, 2016
(86) PCT No.: PCT/AU2016/050763

§ 371 Date: Feb. 17, 2018

(30) Foreign Application Priority Data
Aug. 18, 2015 (AU) 2015101129
Aug. 18, 2015 (AU) 2015903337

(51) Int. Cl. G07D 7/12; B42D 25/324; B42D 25/328; G02B 5/18; B42D 25/29

(52) U.S. Cl. CPC G07D 7/12; B42D 25/324; B42D 25/29; G02B 5/1842; G02B 5/1828; B42D 25/328

(57) ABSTRACT

An optical device, preferably for use in security devices and documents, comprising an arrangement of wavelength dependant optical phase, and optionally amplitude, modifying optical elements on a first surface of a substrate, each of the optical elements being in the form of an optical antenna and configured to produce a local phase change to reflected and/or transmitted electromagnetic waves, the arrangement configured such that the combined action of each of the optical elements produces a pre-defined optical effect on reflection and/or transmission observable by a viewer when the arrangement is illuminated by an external electromagnetic source.

### FIELD OF THE INVENTION

The invention generally relates to optical devices, in particular those for use in providing security to documents.

### BACKGROUND TO THE INVENTION

It is well known that various types of optical microstructures or optically variable devices (OVDs) can be used to protect valuable documents such as banknotes from counterfeiting. Such optical microstructure technologies include diffractive devices such as holograms, Kinegrams(R) and Exelgrams(R), and various other proprietary technologies of this type.

However, it has been found that as technology has developed, some types of diffractive OVDs, such as holograms, are now able to be simulated or copied using commercially available off-the-shelf holography systems such as dot matrix systems. There has been strong interest from security printers in trying to find alternative optical technologies that are more difficult, if not impossible, for counterfeiters to satisfactorily mimic using current technologies.

Alternative OVD technologies that have been developed in an effort to reduce the ability for counterfeiters to satisfactorily reproduce optical effects include micromirror and microlens based optical effects. However there are certain difficulties in trying to manufacture these micromirror, microprism or lenslet array technologies. These difficulties relate to the accuracy to which such micro-optical element arrays can be manufactured so as to produce light beam directional changes of sufficient precision.

Also, these micromirror and microlens arrays require a sufficient thickness of substrate to form the optical elements. This thickness often results in issues when stacking documents (in particular banknotes). Though each individual banknote may comprise an OVD structure that extends by 10 s of microns above the surface of the note, when a large number of notes are stacked together the cumulative effect of the OVD structures creates stacking problems (so-called “profile issues”).

### SUMMARY OF THE INVENTION

In light of this, according to an aspect of the present invention, there is provided an optical device comprising an arrangement of wavelength dependant optical phase modifying optical elements on a first surface of a substrate, each of the optical elements being in the form of an optical antenna and configured to produce a local phase and/or amplitude change to reflected and/or transmitted electromagnetic waves, the arrangement configured such that the combined action of each of the wavelength dependant optical phase modifying optical elements produces an pre-defined optical effect on reflection and/or transmission observable by a viewer when the arrangement is illuminated by an external electromagnetic source.

Typically, the electromagnetic source is a visible light source. The viewer may be a naked eye. Preferably, the observed optical effect is an image configured to change in form and/or colour with changing angle of view and/or changing angle of illumination.

Preferably, each of the optical elements is also a wavelength dependent optical amplitude modifying optical element.

In an embodiment, the optical device further comprises a plurality of pixel elements, wherein each pixel element comprises a plurality of wavelength dependant optical phase modifying optical elements, wherein each optical element is configured to cause a pre-defined local phase modulation of incident electromagnetic waves such that the combined phase modulation of the optical elements within a pixel element cause a characteristic interaction with the incident electromagnetic wave in the region of the pixel element. Each pixel element may have a maximum extent in at least one dimension of 100 microns. Optionally, each pixel element is configured to provide a focusing effect corresponding to the change in propagation of the incident electromagnetic wave, for example, wherein the focusing effect for each pixel element is configured to mimic a refractive cylindrical or spherical microlens. Alternatively, each pixel element may be configured to provide a change in propagation direction of the incident electromagnetic wave, for example, wherein each pixel element is configured to provide a change in propagation direction mimicking a refractive microprism or a reflective micromirror.

The optical elements may be in the form of two-limbed rods (e.g. having a “V”, “L” or “I” shape). In this case, each optical element may be rotated at any predetermined angle with respect to an axis normal to the surface of the device. Alternatively, the optical elements may be in the form of squares, circles, ellipses, rectangles or any other polygon. The optical antennae may be in the form of optical dielectric resonator antennas (DRA) of cylindrical or pill box shape, preferably wherein each optical element has predetermined diameter selected based on the required local phase or amplitude change for the optical element. Alternatively, the optical elements are in the form of square or rectangular box shaped structures, preferably wherein each optical element has at least one predetermined length selected based on the local phase or amplitude change required for the optical element.

Typically, the maximum surface extent of each wavelength dependant optical phase modifying optical element in at least one dimension may be less than 10 microns. Preferably, each optical element extends from the surface of the substrate by no more than 1 micron.

Preferably, the pre-defined optical effect includes an image which appears to the naked eye to lie above or below first surface of the substrate.

According to another aspect of the invention, there is provided a double layer optical device, comprising a first optical device according to the first aspect and a second optical device according to the first aspect located opposite the first optical device, preferably in a spaced apart manner, wherein the image observed looking through the first optical device onto the second optical device is a composite image.

Preferably, the wavelength dependant optical phase modifying optical elements are formed from an embossed and cured radiation curable ink applied to the first surface or formed from a directly embossed substrate, preferably wherein the substrate is a polymer substrate.

Optionally, the optical device is incorporated into a document, such as a banknote or cheque, preferably affixed to or formed directly onto a document substrate of the document.

According to yet another aspect of the invention, there is provided a method of manufacturing the optical device of the first aspect, including the steps of: preparing a shim having an inverse profile to a required profile of the arrangement of optical elements; applying to a surface of a substrate, preferably a transparent substrate, a radiation curable ink; embossing the radiation curable ink with the shim, and curing the radiation curable ink, thereby forming the arrangement of optical elements.

Advantageously, the present invention provides a novel approach to the design of optically variable micro- and nano-structures. For example, the cumulative phase change resulting from the combined interactions of a plurality of optical elements can produce similar interactions with an incoming light wave to those produced by micromirrors, microprisms, and microlenses, which are known in the art of optical security devices. The optical elements beneficially have a relatively small surface profile, in particular when compared to the aforementioned structures known in the art of optical security devices, while providing similar optical effects.

Also advantageously, the optical elements typically have a smaller footprint than conventional micromirrors, microprisms, and microlenses, enabling for an increased resolution focussing or reflection capability when compared to these conventional technologies.

Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Refractive Index n

The refractive index of a medium n is the ratio of the speed of light in vacuum to the speed of light in the medium. The refractive index n₂ of a lens determines the amount by which light rays reaching the lens surface will be refracted, according to Snell's law:

n₁·sin (θ₁)=n₂·sin (θ₂)

where θ₁ is the angle between an incident ray and the normal at the point of incidence at the lens surface, θ₂ is the angle between the refracted ray and the normal at the point of incidence, and n₁ is the refractive index of air (as an approximation n₁ may be taken to be 1).

Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

Metallic Nanoparticle Ink

As used herein, the term metallic nanoparticle ink refers to an ink having metallic particles of an average size of less than one micron.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIGS. 1a and 1d show different document designs comprising an optical device according to embodiments;

FIG. 2 shows an arrangement of pixel elements each comprising an arrangement of wavelength dependant optical phase modifying optical elements;

FIG. 3 shows a pixel element configured to focus incident light rays;

FIG. 4a shows a pixel element configured to reflect incident light rays;

FIG. 4b shows an arrangement of optical elements;

FIG. 5 shows another arrangement of optical elements designed to focus incoming light waves at a point focus;

FIG. 6a shows a series of optical elements providing different local phase changes;

FIG. 6b shows the combined effect on a propagating plane wave of a collection of optical elements;

FIG. 6c shows an arrangement of optical elements providing local phase changes;

FIG. 7a shows a 7 element palette of pixel elements; and

FIG. 7b shows an OVD layer designed utilising the pixel palette of FIG. 7a.

### DESCRIPTION OF PREFERRED EMBODIMENT

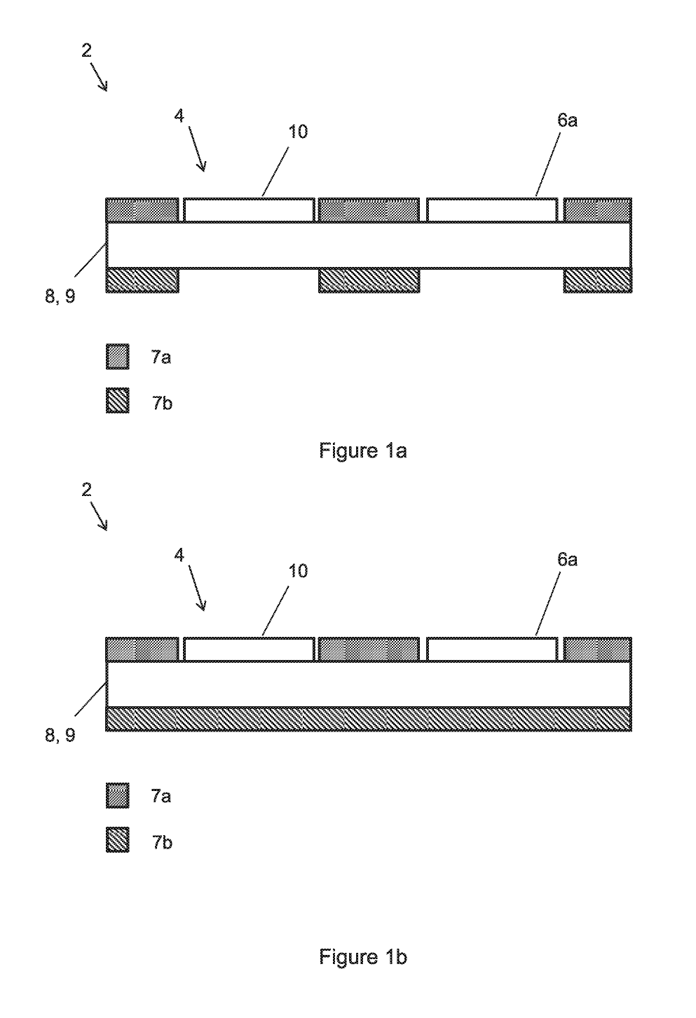

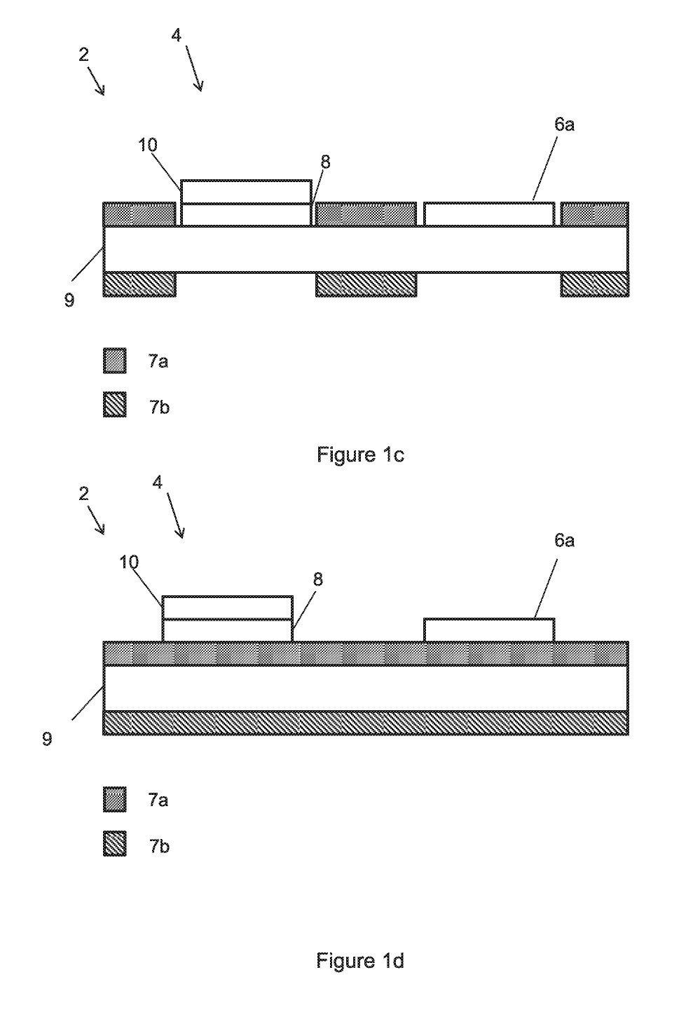

FIGS. 1a to 1d each show a document 2 having a document substrate 9 and an optical device 4 according to embodiments of the invention. The optical device 4 is formed from an optically variable device (OVD) layer 10 located on a first side of a device substrate 8. In the embodiments of FIGS. 1a and 1b, the device substrate 8 is the same as the document substrate 9. In the embodiments of FIGS. 1c and 1d, the device substrate 8 is different to the document substrate 9, and the optical device 4 is affixed to the document substrate 9.

The document 2 includes first and second opacifying layers 7a, 7b applied to opposite sides of the document substrate 9. This is particularly useful for transparent or translucent document substrates 9, as the opacifying layers 7a, 7b act to reduce the transparency of the document 2 in the regions in which the layers 7a, 7b are present.

In the embodiment of FIG. 1a, the OVD layer 10 is located in a “window” region of the document 2; that is, in a region where the first and second opacifying layers 7a, 7b are not present. This enables viewing of the optical device 4 from either side of the document 2.

In the embodiment of FIG. 1b, the OVD layer 10 is located in a “half-window” region of the document 2; that is, in a region where the first opacifying layer 7a is not present and the second opacifying layer 7b is present such that the optical device 4 is viewable only from one side of the document 2. A variation of this embodiment, not shown, has the first opacifying layer 7a present in the region of the OVD layer 10 and the second opacifying layer 7b not present in the same region.

In the embodiment of FIG. 1c, the optical device 4 is affixed onto the document substrate 9 in either a window region (shown) or a half-window region (not shown). In the embodiment of FIG. 1d, the optical device is affixed onto the first opacifying layer 7a of the document 2.

Though not shown in the figures, it is also possible for the document 2 to be inherently opaque (or substantially opaque), for example where the document substrate 9 is paper or a paper composite material. In this case, the opacifying layers 7a, 7b are not necessarily required. The optical device 4 can be formed onto the opaque document substrate 9 (in a similar manner to the embodiments of FIGS. 1a and 1b) or affixed to the document substrate 9 (in a similar manner to the embodiments of FIGS. 1c and 1d). Furthermore, the optical device 4 may be affixed in a cut-out region of the opaque document substrate 9.

Generally, there exists a number of ways for forming an optical device 4 onto a document 2 such that the optical device 4 is either viewable from one side only or both sides of the document 2, as required for the particular implementation.

The optical device 4 typically provides a security function, that is, the optical device 4 acts to decrease the susceptibility of the document 2 to counterfeiting. The optical device 4 can be referred to as a “security device” or “security token” when used for this purpose. A document 2 requiring protection to counterfeiting is often referred to as a “security document”.

FIGS. 1a to 1d also show further security features 6 which can assist in reducing the susceptibility of the document 2 to counterfeiting in combination with the optical device 4. In FIG. 1a, the further security feature 6 is implemented in a window region of the document 2, whereas in FIG. 1b the further security feature 6b is implemented in an opaque (i.e. non-window) region of the document 2. In FIGS. 1c and 1d, the further security feature 6 is affixed onto the document substrate 9 (FIG. 1c) or an opacifying layer (FIG. 1d). The illustrated arrangements are simply examples, and generally the document 2 can include one or more security features 6, each implemented in a window, half-window, or opaque region of the document 2. Example further security features 6 include: optically variable devices such as diffractive optical elements, Kinograms®, microlens based features, holograms, etc; watermark images; fine print; etc.

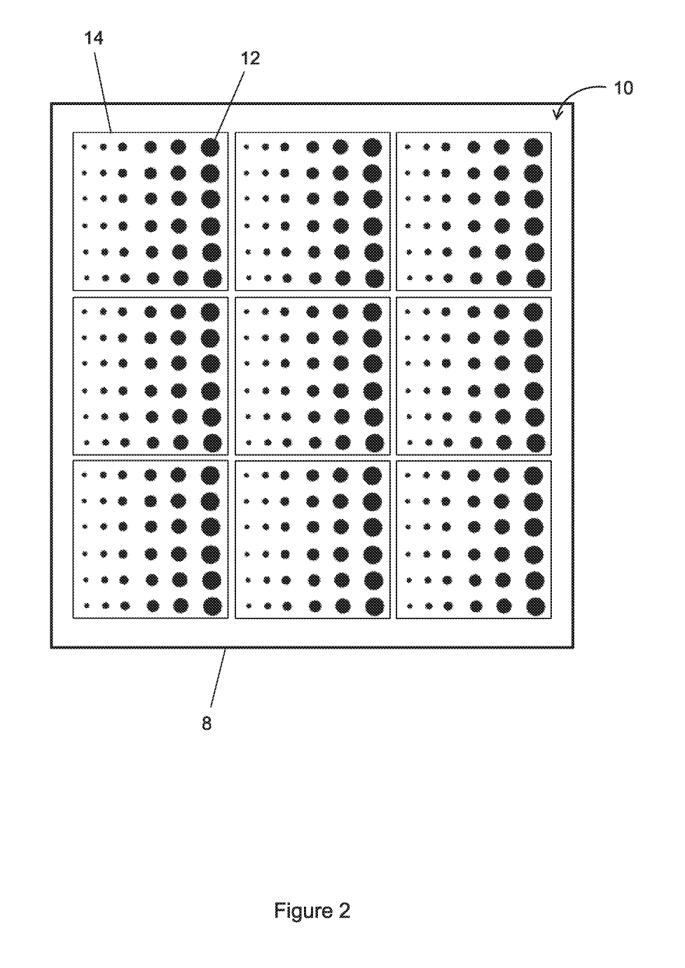

Referring to FIG. 2, the OVD layer 10 comprises an arrangement of optical elements 12, which can be formed from an embossed and cured radiation curable ink applied to a surface of the device substrate 8. The optical elements 12 typically extend from the surface of the device substrate 8, and can be metallised. The optical elements 12 are typically grouped into pixel elements 14, each pixel element 14 comprising one or more, and typically a plurality of, optical elements 12. Each pixel element 14 is configured to produce a characteristic interaction with incoming electromagnetic waves 16 (herein referred to as light waves 16) within the region of the pixel element 14. For example, each pixel element 14 can be configured to produce a characteristic local change in propagation direction of the incident light wave. The local interaction is determined by the distribution of the one or optical elements 12 within the pixel element 14. In this manner, the optical elements 12 act as optical antennae, and the combination of different optical antennae provide for the characteristic interaction of the pixel element 12.

It should be appreciated that, optical elements in all embodiments described herein can be considered to be in the form of optical antennae. It should also be appreciated that the interaction that an optical element, as described herein, with electromagnetic radiation is not diffractive in nature. Instead, it is an abrupt phase, and potentially also an amplitude, change caused by the individual optical element, which when repeated amongst many optical elements, in pre-defined arrangements and forms, causes a defined optical interaction to occur. These types of interactions are discussed in Nanfang Yu et al, “Light propagation with phase discontinuities: generalized laws of reflection and refraction”, Science 334, p333, 2011 and Zou et al., “Dielectric resonator nanoantennas at visible frequencies”, Optics Express, Vol 21, No. 1, p. 1344, 2013.

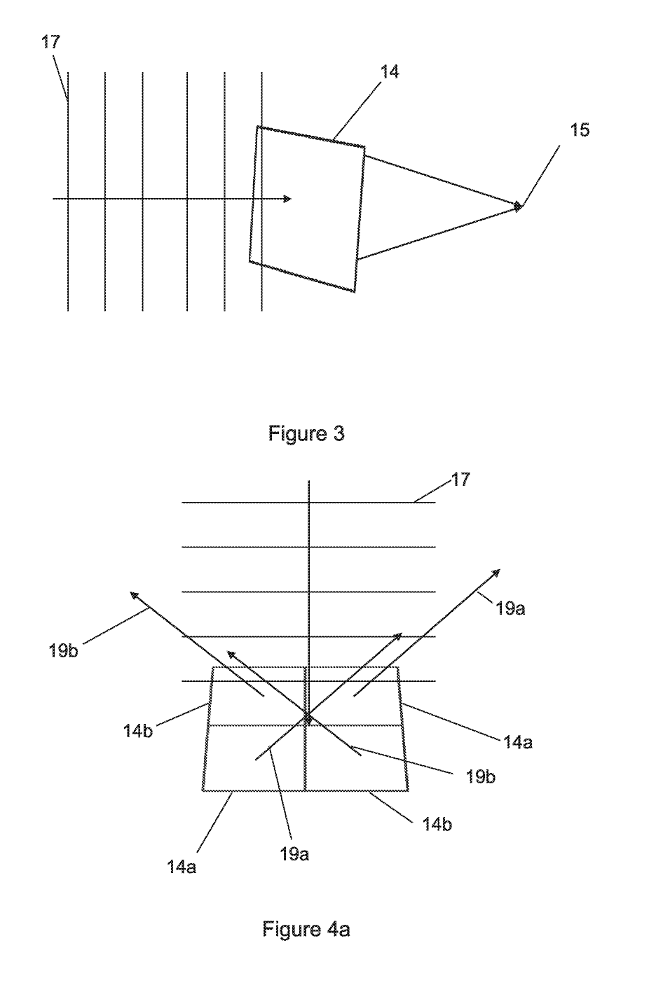

According to an embodiment, as shown in FIG. 3, each individual pixel element 14 is configured to provide a focusing effect. The arrangement of optical elements 12 within a single pixel element 14 is selected such that the characteristic interaction with an incident light wave acts to redirect the light wave such that it forms a different shape as a transmitted light wave. For example, each pixel element 14 is configured to produce a change in the incident light wave 17 such that the transmitted light wave forms a focal point 15 (as shown in FIG. 3) or focal line (not shown), in a manner mimicking a spherical or cylindrical convex lens (respectively). In a variation of this embodiment, each pixel element 14 is configured to reflect the incident light, for example in a similar manner mimicking a concave mirror.

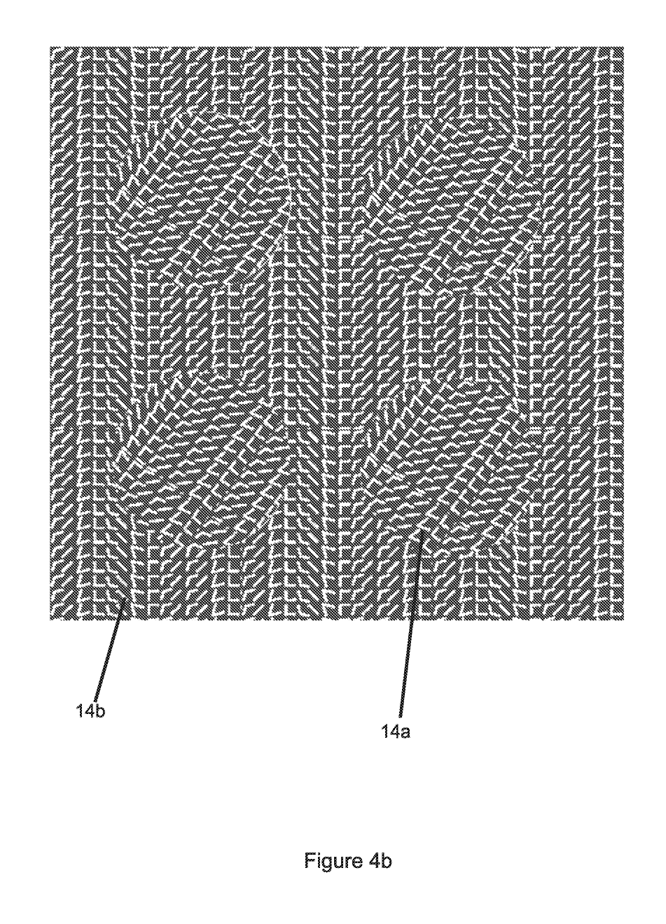

According to another embodiment, with reference to FIGS. 4a and 4b, each pixel element 14 can be configured to cause a change in direction of propagation of incident light (in the region of the pixel element 14) but no, or minimal, change in the form of the incident light. In one implementation, each pixel element 14 deflects incident light in a manner mimicking a flat micromirror located at an angle with respect to the plane of the device substrate 8 (i.e. the light is reflected). In another implementation, each pixel element 14 deflects incident light in a manner mimicking a microprism (i.e. the light is transmitted). In each case, the light is reflected or refracted towards an angle different to that expected based on the flat device substrate 8.

The embodiment shown in FIGS. 4a and 4b is utilised to create an optically variable effect wherein each pixel element 14a, 14b is assigned to one of a plurality of images. The pixel elements 14a, 14b associated with the same image are configured to deflect incident light in the same (or substantially the same) direction 19a, 19b, with the direction associated with each image being different. In this way, on tilting the optical device 4 or otherwise changing the relative position between the optical device 4, observer, and light source, the appearance of the optical device 4 changes between the different images. FIG. 4b shows a small section of an OVD layer 10 containing irregular shaped pixel elements 14a, 14b configured to convert incoming light waves into a predetermined distribution of outgoing light waves that mimics the action of a micromirror or microprism array. A typical size of the section shown is of the order of 20 microns×20 microns or less.

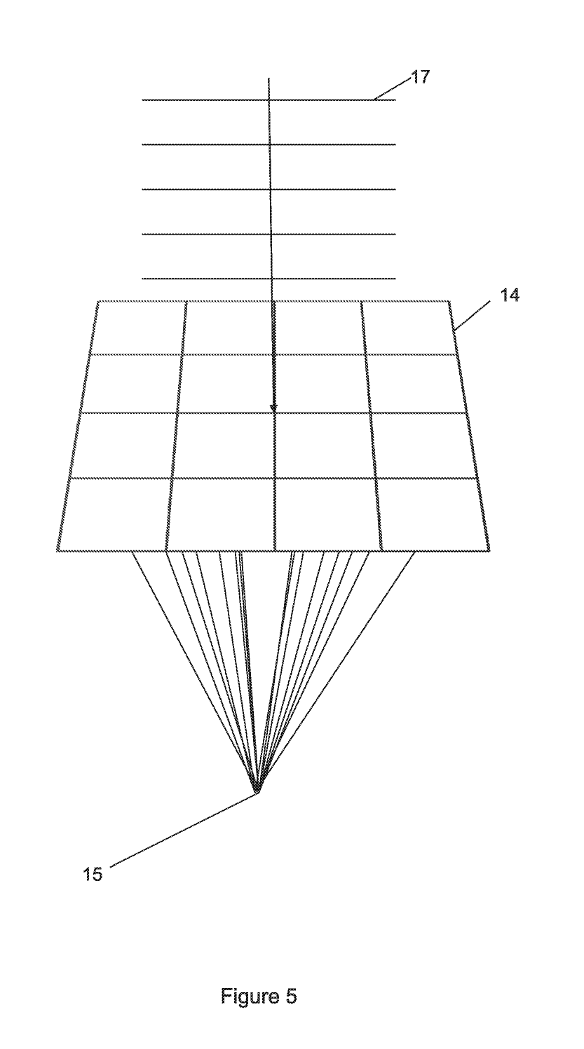

According to another embodiment, as shown in FIG. 5 the pixel elements 14 are configured and arranged with respect to one another in order to provide a focusing effect. According to this embodiment, the focusing effect is the result of the interaction of the plurality of pixel elements 14, which is herein referred to as a lens arrangement 50. In this way, the pixel elements 14 working in combination provide an optical effect similar to a refractive conventional lens (as shown in FIG. 5) or a curved mirror (not shown). According to this embodiment, each pixel element 14, considered on its own, acts as a flat micromirror or microprism, and the combined deflections of the pixel elements 14 act to direct to incident light wave to a single point (either located on the same side or opposite side of the OVD layer 10 to the incident light).

Optical elements 12 correspond to structures which each act to impose sudden phase changes on incident light waves. The sudden phase change is both local (i.e. occurring in the vicinity of a particular optical element 12) and controlled (i.e. the degree of phase change is proportional to the shape and orientation of the particular optical element 12). The optical elements 12 can therefore be considered as optical antennae. The optical elements 12 typically have a height less than 1 micron, preferably less than 500 nanometres, more preferably less than 250 nanometres. The optical elements 12 can have at least one length dimension, if not both length dimensions, less than 10 microns, preferably less than 1 microns, and more preferably less than 750 nanometres.

The pixel elements 14 typically will have at least one length dimension less than 100 microns, preferably less than 50 microns. The optical elements 12, and the pixel elements 14, are therefore able to provide relatively high resolution optical effects similar to existing lens (e.g. microlens) and mirror (e.g. micromirror) optical effects, without the bulk geometry requirements of these conventional optical elements.

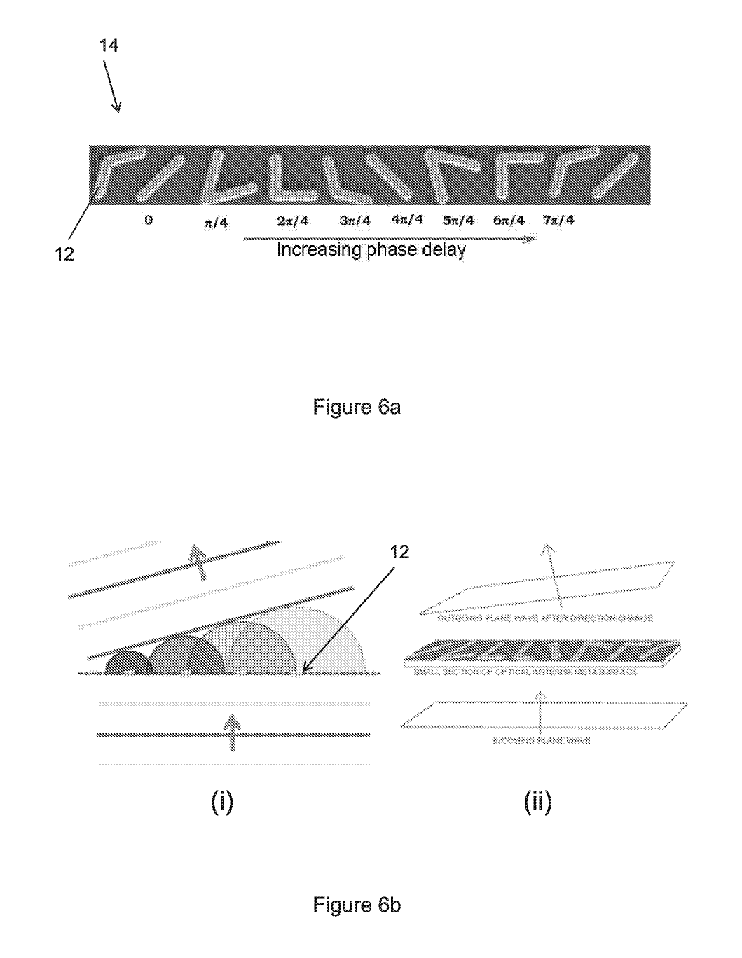

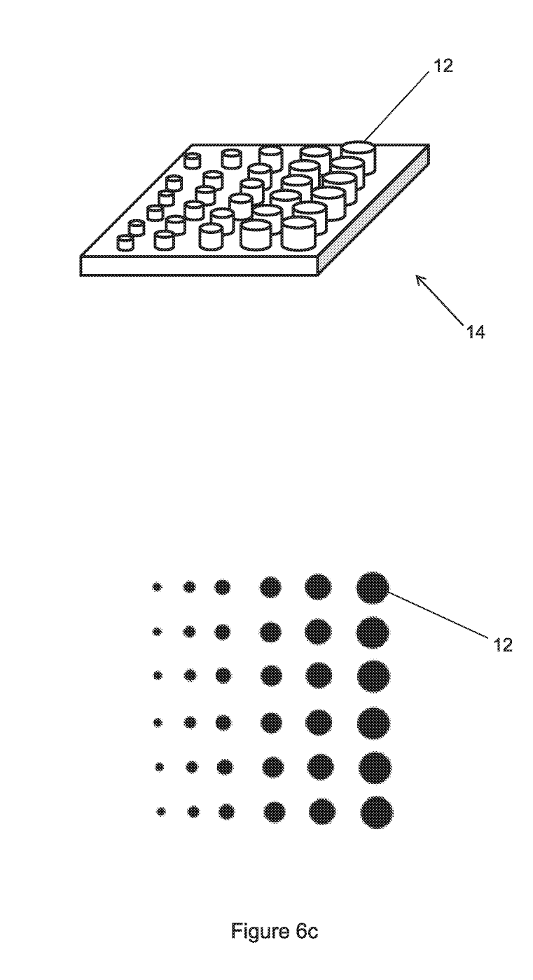

FIG. 6a shows an example of different optical elements 12, each configured to produce a different phase change (between 0 and 7π/4). In this example, the optical elements 12 are of the form of two-limbed rods, arranged as “V” shaped, “L” shaped, and “I” shaped rods. Referring to FIG. 6b, the combined effect of the eight different optical elements 12 shown in FIG. 6a, which act to change the direction of an incoming plane wave. As each optical element 12 causes a different phase shift, the overall direction of propagation of the plane wave is altered. The particular arrangement of optical elements 12 shown constitutes a pixel element 14. This is explained by Huygens's principle where each point of a wavefront acts as a source of secondary wavelets, as shown in (i). Further discussion about optical elements 12 in the form of V-shaped rods can be found in Nanfang Yu et al, “Light propagation with phase discontinuities: generalized laws of reflection and refraction”, Science 334, p333, 2011. This arrangement can be considered a pixel element 14 configured as a microprism, as the direction of propagation of the incident light wave is changed, but not the overall form (i.e. the transmitted light wave is also a plane wave).

Considering the specific example shown in FIGS. 6a and 6b, the deflection caused by the combined action of the eight optical elements 12 can be determined at least in part by the spacing between adjacent optical elements 12. In this way, different pixel elements 14 can be designed having different deflection angles through selection of a characteristic optical element 12 spacing associated with the pixel elements 14. It is envisaged that a single pixel element 14 may comprise a plurality of repetitions of the eight optical elements 14 shown in FIGS. 6a and 6b.

FIG. 6c shows another example of different optical elements 12, which take the form of cylinders or “pill boxes”. As with the example of FIGS. 6a and 6b, a pixel element 14 is defined by an arrangement of such optical elements 12. The particular pixel element 14 shown results in a reflection of an incoming light beam. If each optical element 12 is chosen with a diameter (e.g. from 20 nm to 200 nm) such that there is a progressive phase increment of 60 degrees then 6 elements can generate a phase ramp of 360 degrees. In this case, the effective deflection angle of the mirror-effect is given by sin (θ)=pΔ/2πa, where “ a” is the unit cell size, “Δ” is the wavelength of the incoming light, and “p” is the phase increment. Further discussion about optical elements 12 having a pill-box configuration can be found in Zou et al., “Dielectric resonator nanoantennas at visible frequencies”, Optics Express, Vol 21, No. 1, p. 1344, 2013.

The local phase change caused by a particular optical element 12 is in part determined by the diameter of the optical element 12. Similar to the embodiment of FIGS. 6a and 6b, a suitable arrangement of optical elements 12 with different diameters can cause a characteristic deflection in the propagation direction of an incident light wave. Similar to the embodiment of FIGS. 6a and 6b, the embodiment of FIG. 6c can include different pixel elements 14 designed having different deflection angles through selection of a characteristic optical element 12 spacing associated with the pixel elements 14.

Other shapes of optical elements 12 are possible. For example, optical elements 12 with a square, rectangular, or other polygon shaped cross-section are envisaged.

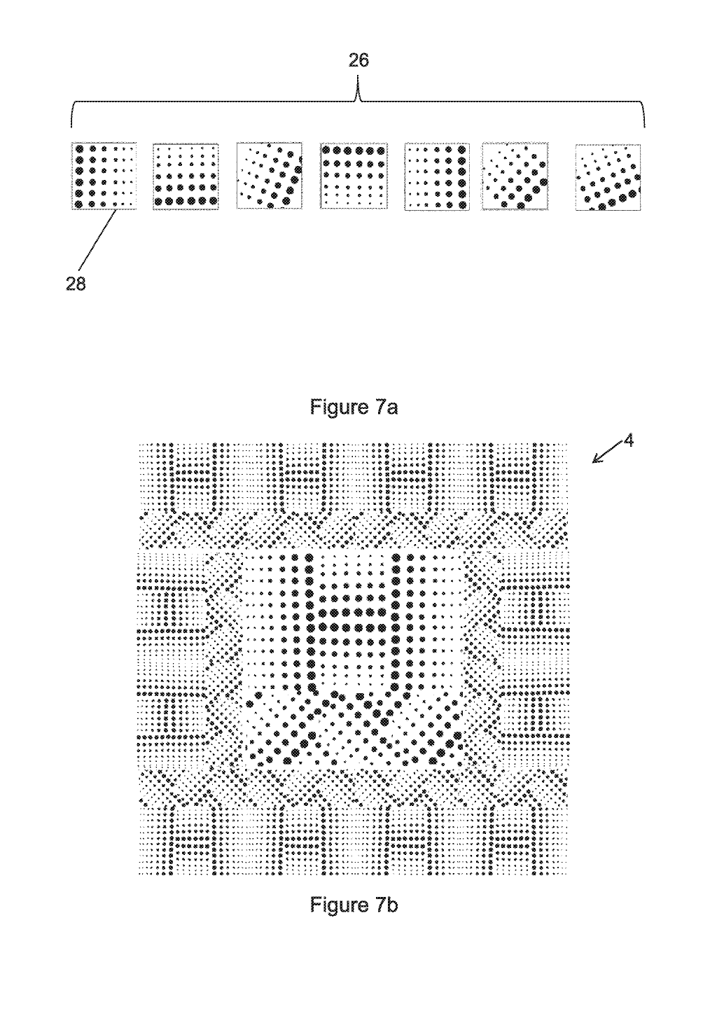

As shown in FIGS. 7a and 7b, for the purposes of determining a required arrangement of optical elements 12, a palette 26 comprising a plurality of pixel templates 28 is provided. FIG. 7a show a palette 26 of seven pixel templates 28 which allows for simplified design of the optical effect. In FIG. 7a, each pixel template 28 is characterised by an associated rotation. FIG. 7b shows the layout of an optical device 4 designed through use of the palette 26 of FIG. 7a. Each pixel element 14 is selected from the pixel templates 28 of the palette 26 based on a required rotational direction. The actual pixel element 14 is then determined based on the pixel template 28 and a required pixel size (which determines, as previously discuss, the deflection caused by the pixel element 14). The resulting optical device 4 shows an optically variable effect where different parts of the optical device 4 “light up when it is viewed from different rotational directions and different tilt directions.

The arrangement of optical elements 12 can also provide a structural colour effect where the phase shifting or deflection effect is a function of the wavelength of the incoming light as (e.g) as shown by the equation sin (θ)=pΔ/2πa of Zou et al.

Further modifications and improvements may be incorporated without departing from the scope of the invention.

1. A security document including an optical device as a security feature of the document, wherein said optical device comprises:
a substrate,
an arrangement of wavelength dependant optical phase modifying optical elements on a first surface of the substrate, each of the optical elements being in the form of an optical antenna and configured to produce a local phase change to incident electromagnetic waves, the arrangement configured such that the combined action of the optical elements produces a pre-defined optical effect of the incident electromagnetic waves observable by a viewer.

2. A security document according to claim 1, wherein each of the optical elements is also a wavelength dependent optical amplitude modifying optical element.

3. A security document according to claim 1, wherein the incident electromagnetic waves are provided by a visible light source and the viewer is a naked eye.

4. (canceled)

5. A security document according to claim 1, wherein the observed optical effect is an image configured to change in form and/or colour, and/or an image which appears to the naked eye to lie above or below first surface of the substrate, with changing angle of view and/or changing angle of illumination.

6. A security document according to claim 1, further comprising a plurality of pixel elements, wherein each pixel element comprises a plurality of the wavelength dependant optical phase modifying optical elements, wherein each optical element is configured to cause a pre-defined local phase modulation of the incident electromagnetic waves such that the combined phase modulation of the optical elements within a pixel element cause a characteristic interaction with the incident electromagnetic waves in the region of the pixel element.

7. A security document according to claim 6, wherein each pixel element has a maximum extent in at least one dimension parallel to the substrate of 100 microns.

8. A security document according to claim 6, wherein each pixel element is configured to provide a focusing effect corresponding to a change in propagation of the incident electromagnetic waves.

9. A security document according to claim 8, wherein the focusing effect for each pixel element is configured to mimic a refractive cylindrical or spherical microlens.

10. A security document according to claim 6, wherein each pixel element is configured to provide a change in propagation direction of the incident electromagnetic waves by mimicking a refrative microprism or a reflective micromirror.

11. (canceled)

12. A security document according to claim 1, wherein the optical elements are in the form of two-limbed rods having a “V”, “L” or “I” shape.

13. A security document according to claim 12, wherein each optical element is rotated at any predetermined angle with respect to an axis normal to the surface of the device.

14. (canceled)

15. A security document according to claim 1, wherein the optical elements are in the form of optical dielectric resonator antennas (DRA) of cylindrical or pill box shape.

16. A security document according to claim 15, wherein each optical element has a predetermined diameter selected based on the required local phase change for the optical element.

17. A security document according to claim 1, wherein the optical elements are in the form of square or rectangular box shaped structures and each optical element has at least one predetermined length selected based on the local phase change required for the optical element.

18. (canceled)

19. A security document according to claim 1, wherein the maximum surface extent of each optical element in at least one dimension parallel to the substrate is less than 10 microns.

20. A security document according to claim 1, wherein the pre-defined optical effect includes an image which appears to the naked eye to lie above or below first surface of the substrate.

21. A security document according to claim 1, wherein each optical element extends from the surface of the substrate by no more than 1 micron.

22. A security document including a double-layer optical device, said double layer optical device comprising a first optical device according to claim 1 and a second optical device according to claim 1 located opposite to the first optical device, in a spaced apart manner, wherein the image observed looking through the first optical device onto the second optical device is a composite image.

23. A security document according to claim 1, wherein the optical elements are formed from an embossed and cured radiation curable ink applied to the first surface or formed from a directly embossed substrate, wherein the substrate is a polymer substrate.

24. A security document according to claim 1, the optical device is affixed to or formed directly onto a document substrate of the security document, wherein the security document is a banknote or cheque.

25. A method of manufacturing the optical device of the security document of claim 1, including the steps of:
preparing a shim having an inverse profile to a required profile of the arrangement of optical elements;
applying to a surface of a transparent substrate a radiation curable ink;
embossing the radiation curable ink with the shim, and curing the radiation curable ink, thereby forming the arrangement of optical elements.
